(19) United States
(12) Patent Application Publication
(10) Pub. No.: US 2011/0062843 A1
(43) Pub. Date: Mar. 17, 2011

(54) Face Frame Assembly

(75) Inventor: Andy Burgess, Eau Claire, WI (US)

(73) Assignee: MENARD, INC., Eau Claire, WI (US)

(21) Appl. No.: 12/883,351

(22) Filed: Sep. 16, 2010

Related U.S. Application Data
(60) Provisional application No. 61/242,876, filed on Sep. 16, 2009.

(51) Int. Cl. A47B 96/00; B23P 11/00

(52) U.S. Cl. 312/326; 312/352; 29/428

(57) ABSTRACT

A face frame assembly constructed to include an inside stile that extends from a top surface to a bottom surface to increase load bearing capability of the face frame assembly. Additionally, the face frame assembly is fully assembled prior to routing a joining recess used to join the face frame assembly to a cabinet box.

### CROSS-REFERENCE TO RELATED APPLICATION

The present application claims the benefit of U.S. Provisional Patent Application No. 61/242,876, filed Sep. 16, 2009, the entirety of which is hereby incorporated by reference.

### BACKGROUND

Face-frame cabinets typically include a face frame joined to a cabinet box face. A top surface of the cabinet box may be fitted with a working surface such as, for example, a granite countertop. Sinks or other similar amenities can be incorporated into the working surface. The face frame supports at least a portion of the load of the working surface by virtue of being joined to the cabinet structure. If the structural integrity of the face frame is compromised by weight imparted by the working surface, undesired compression and tensile forces may develop and subsequently damage the working surface.

### SUMMARY

In one example aspect, a cabinet face frame includes: an inner support stile; a first top rail and a second top rail coupled to a first end of the inner support stile; a first bottom rail and a second bottom rail coupled to a second opposite end of the inner support stile; a first side stile coupled to the first top rail and the first bottom rail; and a second side stile coupled to the second top rail and the second bottom; wherein the inner support stile extends from a common top surface of the first and second top rail to an opposite common bottom surface of the first and second bottom rail, and wherein the cabinet face frame is fully assembled prior to formation of joinery within at least the first side stile, second side stile, first bottom rail, and second bottom rail.

In another example aspect, a cabinet assembly includes: a cabinet box; a cabinet face frame joined to the cabinet box, comprising: an inner support stile; a first top rail and a second top rail coupled to a first end of the inner support stile; a first bottom rail and a second bottom rail coupled to a second opposite end of the inner support stile; a first side stile coupled to the first top rail and the first bottom rail; and a second side stile coupled to the second top rail and the second bottom; wherein the inner support stile extends from a common top surface of the first and second top rail to an opposite common bottom surface of the first and second bottom rail, and wherein the face frame is fully assembled prior to formation of joinery within at least the first side stile, second side stile, first bottom rail, and second bottom rail; and a working surface positioned to and supported by the cabinet box and the cabinet face frame to form the cabinet assembly.

In yet another example aspect, a method of forming a cabinet face frame assembly includes: providing an inside stile, a first top rail, a second top rail, a first bottom rail, a second bottom rail, a first side stile, and a second side stile to form the cabinet face frame assembly; coupling the first top rail and the second top rail to a first end of the inside stile; coupling the first bottom rail and the second bottom rail is joined to a second opposite end of the inside stile, wherein the inside stile extends from a common top surface of the first and second top rail to an opposite common bottom surface of the first and second bottom rail; coupling the first side stile to the first top rail and the first bottom rail; coupling the second side stile to the second top rail and the second bottom; and forming joinery within at least the first side stile, second side stile, first bottom rail, and second bottom rail.

### DESCRIPTION OF THE DRAWINGS

Aspects of the disclosure may be more completely understood in consideration of the following detailed description of various embodiments of the disclosure in connection with the accompanying drawings.

FIG. 1 is a front view of an example face frame assembly for a cabinet.

FIG. 2 is a rear view of the face frame assembly of FIG. 1.

FIG. 3 is a cross-sectional view of the face frame assembly of FIG. 1.

FIG. 4 is an example method for constructing and assembling the face frame assembly of FIG. 1 to a cabinet box face of a face-frame cabinet

### DETAILED DESCRIPTION

The example embodiments described in the following disclosure are provided by way of illustration only and should not be construed as limiting. Various modifications and changes may be made to the example embodiments described below without departing from the true spirit and scope of the disclosure.

The present disclosure relates generally to face-frame cabinets. More specifically, the present disclosure relates to a face frame assembly for a face-frame cabinet.

In example embodiments provided herein, the face frame assembly is constructed to include an inside stile that extends from a top surface of the face frame assembly to a bottom surface of the face frame assembly to increase load bearing capability of the face frame assembly. Additionally, in some embodiments, the face frame assembly is fully assembled prior to forming a joining recess used to join the face frame assembly to a cabinet box. Although the present disclosure is not so limited, an appreciation of the various aspects of the disclosure will be gained through a discussion of the examples provided below.

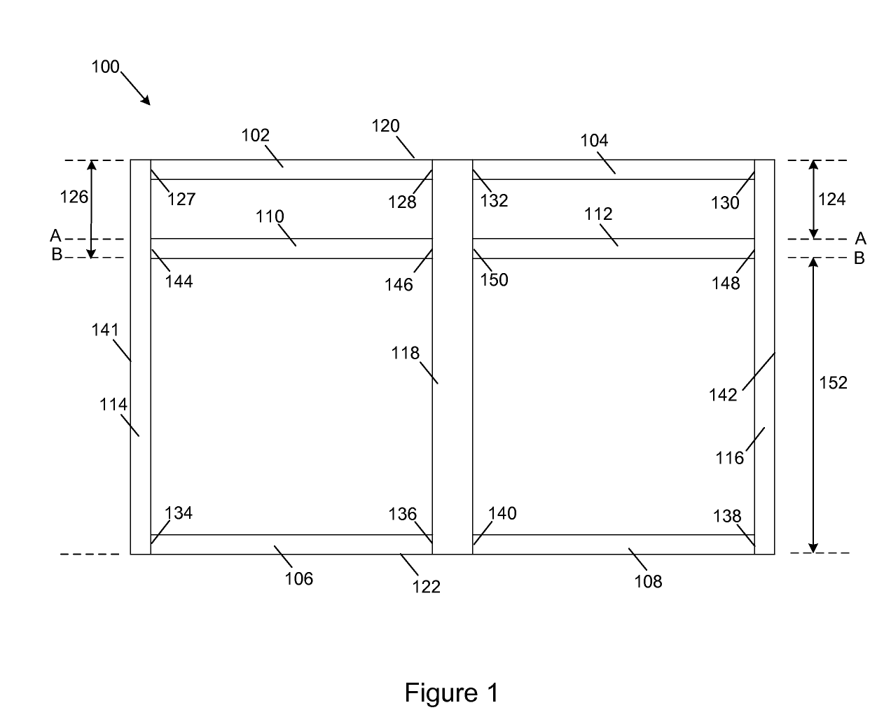

Referring now to FIG. 1, a front view of an example face frame assembly 100 is shown according to the principles of the present disclosure. In general, assembly 100 is sized and constructed to be joined to a cabinet box face of a face-frame cabinet (not shown). Subsequently, assembly 100 may be fitted with various add-ons as desired. For example, assembly 100 may be fitted with doors, drawers, and the like. In this manner, articles may be stored and accessed within the cabinet box. Assembly 100 may additionally be fitted with decorative fascia such as panels and knobs.

Example assembly 100 includes a first top rail 102, a second top rail 104, a first bottom rail 106, a second bottom rail 108, a first inside rail 110, a second inside rail 112, a first side stile 114, a second side stile 116, and an inner stile 118. As depicted in FIG. 1, assembly 100 is constructed such that inner stile 118 extends from a top surface 120 of assembly 100 to an opposite bottom surface 122 of assembly 100. However, other embodiments are possible as well.

For example, assembly 100 may be constructed such that inner stile 118 extends from top surface 120 to first and second inside rail 110, 112 (not shown). For example, inner stile 118 may extend a distance 124 from top surface 120 to a first common plane A of first and second inside rail 110, 112. In the example embodiment, both first and second inside rail 110, 112 and first and second bottom rail 106, 108 are formed as a single inside rail. Alternatively, inner stile 118 may extend a distance 126 from top surface 120 to a second common plane B of first and second inside rail 110, 112 (not shown). In the example embodiment, first and second bottom rail 106, 108 are formed as a single inside rail. Still other embodiments are possible.

For example, in another embodiment, assembly 100 may be constructed such that inner stile 118 is omitted (not shown). In the example embodiment, only first side stile 114 and second side stile 116 extend from top surface 120 to bottom surface 122 of assembly 100. Further, first inside rail 110 and second inside rail 112 are formed as a single rail that extends from first side stile 114 to second side stile 116.

Still referring to FIG. 1, assembly 100 is constructed such that first top rail 102 is joined to first side stile 114 at a first interface 127, and joined to inner stile 118 at a second interface 128. Similarly, second top rail 104 is joined to second side stile 116 at a third interface 130, and joined to inner stile 118 at a fourth interface 132. In the example embodiment, first and second top rails 102, 104 are coupled approximately perpendicular to inner stile 118. Similarly, first and second bottom rail 106, 108 are coupled approximately perpendicular to inner stile 118. It will be appreciated that throughout the present disclosure, any of a plurality of joinery either alone or in combination may used to join respective elements of example assembly 100. Example joinery includes jointing, adhesive, and fastener joinery, and others.

Assembly 100 is further constructed such that first bottom rail 106 is joined to first side stile 114 at a fifth interface 134, and joined to inner stile 118 at a sixth interface 136. Similarly, second bottom rail 108 is joined to second side stile 116 at a seventh interface 138, and joined to inner stile 118 at an eighth interface 140. In this manner, a first side surface 141 and an opposite second side surface 142 of assembly 100 are each adjacent to top surface 120 and bottom surface 122.

Assembly 100 is further constructed such that first inside rail 110 is joined to first side stile 114 at a ninth interface 144, and joined to inner stile 118 at a tenth interface 146. Similarly, second inside rail 112 is joined to second side stile 116 at an eleventh interface 148, and joined to inner stile 118 at a twelfth interface 150. In the example embodiment, first and second inside rail 110, 112 are coupled approximately perpendicular to inner stile 118 offset a pre-determined selectable distance 152 from bottom surface 122 to second common plane B.

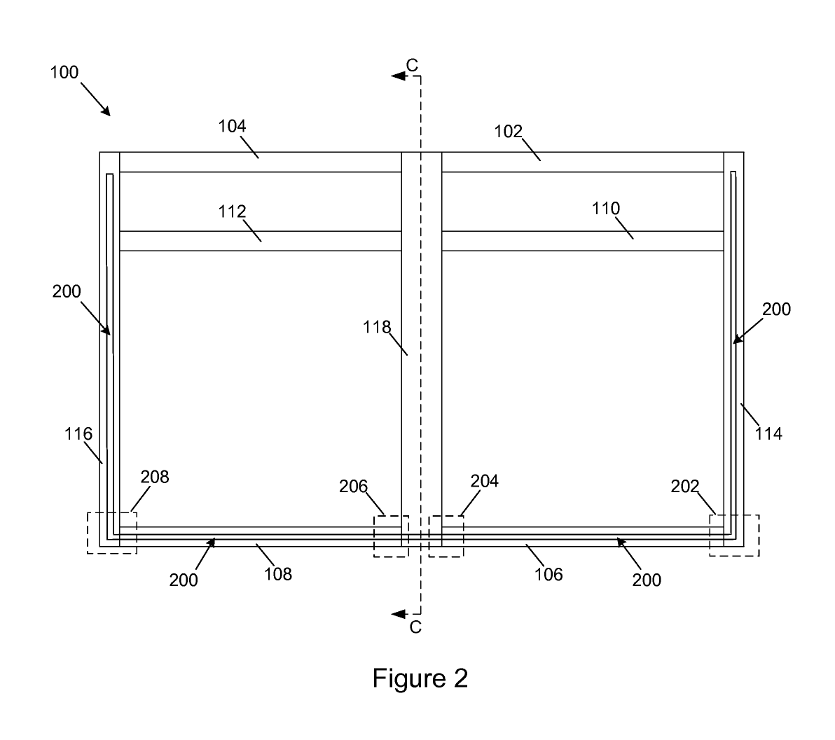

Referring now to FIG. 2, a rear view of the example assembly 100 of FIG. 1 is shown. In the example embodiment, a recess 200 is formed within first bottom rail 106, second bottom rail 108, first side stile 114, and second side stile 116. Recess 200 may be any type of jointing recess configured to join with a complementary feature formed on an adjoining element. For example, recess 200 may be a dado recess configured to be joined with a rebate formed on a cabinet box face. However, other embodiments are possible as well.

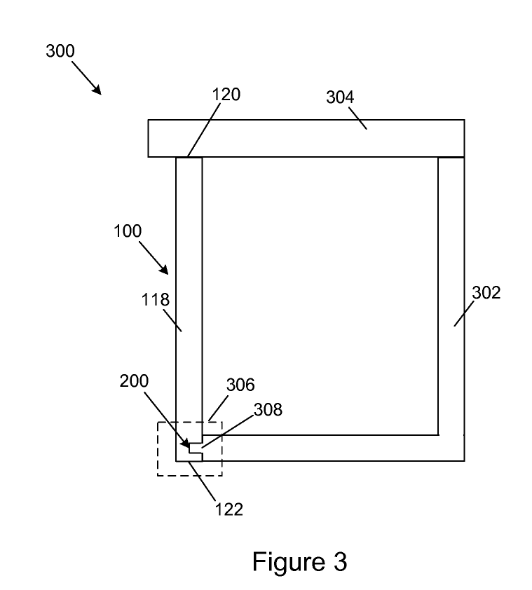

In one aspect, recess 200 is formed within first bottom rail 106, second bottom rail 108, first side stile 114, and second side stile 116 after assembly 100 is fully assembled. In this manner, alignment mismatching of recess 200 at a first section 202, a second section 204, a third section 206, and a fourth section 208 of assembly 100 is minimized. Accordingly, a complementary feature formed on an adjoining element may be inserted into recess 200 as a single, continuous piece, without requiring trimming of the adjoining element to account for mismatching of recess 200. For example, a shelf of a cabinet box (see FIG. 3) can be inserted into recess 200 without requiring corners of the shelf to be removed, since recess 200 extends continuously along rails 106, 108 and stiles 114, 116, and 118.

Other configurations are possible. For example, in another embodiment, recess 200 can be formed partially or entirely in each individual stile and rail before assembly.

Referring now to FIG. 3, a cross sectional view of an assembled cabinet 300 is shown in which assembly 100 of FIGS. 1 and 2 is joined to a cabinet box 302 and includes a working surface 304 positioned thereon. The cross-sectional view corresponds to cross-section C of assembly 100 as shown in FIG. 2. In this manner, inner stile 118 is shown extending from the top surface 120 to the bottom surface 122 of assembly 100. A rebate and dado joint 306 is formed by joining a rebate 308 of cabinet box 302 within recess 200 of assembly 100, as described above.

In a first aspect, configuration of inner stile 118 as shown in FIGS. 1-3 reduces a required length of the first top rail 102, second top rail 104, first bottom rail 106, second bottom rail 108, first inside rail 110, second inside rail 112. In this manner, resources associated with manufacture of assembly 100 are maximized. For example, scrap produced in manufacture of assembly 100 can be reduced.

In another aspect, inner stile 118 increases rigidity and thus load bearing capacity of assembly 100. Accordingly, assembly 100 is constructed such that structural integrity of the assembly 100 is maintained despite use of increasingly heavy and expensive synthetic or non-synthetic working surfaces (e.g., stone, laminate, tile, steel, concrete, wood, and others). In this manner, the working surface is protected from undesired compression and tensile forces that may develop within the working surface upon a compromise in structural integrity of assembly 100.

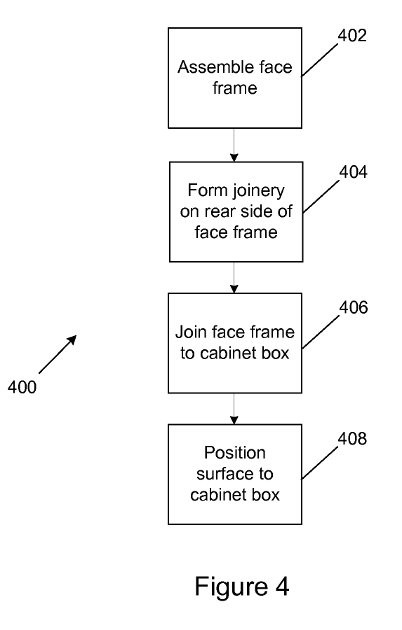

Referring now to FIG. 4, an example method 400 is shown for constructing and assembling a face frame assembly to a cabinet box face of a face-frame cabinet. In general, the face frame assembly is similar to assembly 100 discussed above with respect to FIGS. 1-3.

At operation 402, a face frame assembly comprising a plurality of top rails, bottom rails, inside rails, and outer stiles is fully assembled including an inside stile that extends from a top surface of the assembly to an opposite bottom surface of the assembly. In general, respective elements of the face frame assembly can be formed from synthetic materials, natural materials, and a combination thereof. Next, at operation 404, joinery (e.g., a recess dado) is formed on a rear side of the face frame assembly. In one embodiment, the dado is formed within the plurality of bottom rails and outer stiles of the assembly, as described above with respect to FIG. 3. At operation 406, the face frame assembly is joined to the cabinet box face of the face-frame cabinet to form an assembled cabinet box. At operation 408, a working surface is positioned to the assembled cabinet box.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A cabinet face frame, comprising:
an inner support stile;
a first top rail and a second top rail coupled to a first end of the inner support stile;
a first bottom rail and a second bottom rail coupled to a second opposite end of the inner support stile;
a first side stile coupled to the first top rail and the first bottom rail; and
a second side stile coupled to the second top rail and the second bottom;
wherein the inner support stile extends from a common top surface of the first and second top rail to an opposite common bottom surface of the first and second bottom rail, and wherein the cabinet face frame is fully assembled prior to formation of joinery within at least the first side stile, second side stile, first bottom rail, and second bottom rail.

2. The cabinet face frame of claim 1, wherein the first top rail and the second top rail are orientated approximately perpendicular to the first end of the inner support stile, and wherein the first bottom rail and second bottom rail are orientated approximately perpendicular to the second end of the inner support stile.

3. The cabinet face frame of claim 1, wherein the first side stile and the second side stile are orientated approximately parallel to the inner support stile.

4. The cabinet face frame of claim 1, wherein the first inside rail and the second inside rail are aligned and coupled to the inner support style at a pre-determined selectable distance from the bottom surface.

5. The cabinet face frame of claim 1, wherein the joinery includes at least one of: jointing; adhesive; and fastener joinery.

6. The cabinet face frame of claim 5, wherein the jointing comprises a dado recess.

7. A cabinet assembly, comprising:
a cabinet box;
a cabinet face frame joined to the cabinet box, comprising:
an inner support stile;
a first top rail and a second top rail coupled to a first end of the inner support stile;
a first bottom rail and a second bottom rail coupled to a second opposite end of the inner support stile;
a first side stile coupled to the first top rail and the first bottom rail; and
a second side stile coupled to the second top rail and the second bottom;
wherein the inner support stile extends from a common top surface of the first and second top rail to an opposite common bottom surface of the first and second bottom rail, and wherein the face frame is fully assembled prior to formation of joinery within at least the first side stile, second side stile, first bottom rail, and second bottom rail; and
a working surface positioned to and supported by the cabinet box and the cabinet face frame to form the cabinet assembly.

8. The cabinet assembly of claim 7, wherein the first top rail and the second top rail are orientated approximately perpendicular to the first end of the inner support stile.

9. The cabinet assembly of claim 7, wherein the first bottom rail and second bottom rail are orientated approximately perpendicular to the second end of the inner support stile.

10. The cabinet assembly of claim 7, wherein the first side stile and the second side stile are orientated approximately parallel to the inner support stile.

11. The cabinet assembly of claim 7, wherein the joinery includes at least one of: jointing; adhesive; and fastener joinery configured to join with a complementary feature of the cabinet box.

12. The cabinet assembly of claim 11, wherein the jointing comprises a dado recess configured to be received by a rebate formed on the cabinet box.

13. The cabinet assembly of claim 12, wherein the dado recess extends continuously along the first side stile, second side stile, first bottom rail, and second bottom rail.

14. The cabinet assembly of claim 7, further comprising a plurality of add-ons coupled to a first side of the cabinet face frame.

15. The cabinet assembly of claim 14, wherein the plurality of add-ons are selected from a group comprising: doors; drawers; and decorative fascia.

16. The cabinet assembly of claim 7, wherein the working surface is selected from a group comprising: stone; laminate; tile, steel; concrete; and wood.

17. A method of forming a cabinet face frame assembly, comprising:
providing an inside stile, a first top rail, a second top rail, a first bottom rail, a second bottom rail, a first side stile, and a second side stile to form the cabinet face frame assembly;
coupling the first top rail and the second top rail to a first end of the inside stile;
coupling the first bottom rail and the second bottom rail is joined to a second opposite end of the inside stile, wherein the inside stile extends from a common top surface of the first and second top rail to an opposite common bottom surface of the first and second bottom rail;
coupling the first side stile to the first top rail and the first bottom rail;
coupling the second side stile to the second top rail and the second bottom; and
forming joinery within at least the first side stile, second side stile, first bottom rail, and second bottom rail.

18. The method of claim 17, further comprising:
coupling the first top rail and the second top rail in an approximately perpendicular orientation to the first end of the inside stile;
coupling the first bottom rail and second bottom rail in an approximately perpendicular orientation to the second end of the inside stile; and
coupling the first side stile and the second side stile in an approximately parallel orientation to the inside stile.

19. The method of claim 17, wherein the joinery includes at least one of: jointing; adhesive; and fastener joinery.

20. The method of claim 17, wherein forming joinery comprises forming a continuous dado recess within the first side stile, second side stile, first bottom rail, and second bottom rail.
